(19) United States
(12) Patent Application Publication
(10) Pub. No.: US 2016/0014276 A1
(43) Pub. Date: Jan. 14, 2016

(54) EFFICIENT USE OF UE/NW RESOURCES IN DSDA PHONES AND ACHIEVE BETTER USER EXPERIENCE AND BATTERY SAVING

(71) Applicant: QUALCOMM Incorporated, San Diego, CA (US)

(72) Inventors: Ravi Kanth Kotreka, Hyderabad (IN); Pavan Kumar Kadiyala, Hyderabad (IN)

(21) Appl. No.: 14/326,878

(22) Filed: Jul. 9, 2014

(51) Int. Cl. H04M 3/54; H04W 4/16

(52) U.S. Cl. CPC H04M 3/543; H04W 4/16

(57) ABSTRACT

A method for automatic call forwarding, includes: designating a first subscription as a subscription to receive circuit switched calls and packet switched calls; designating a second subscription as a subscription to receive circuit switched calls; and automatically forwarding a circuit switched call received on the first subscription to the second subscription when a packet switched call is active on the first subscription.

### BACKGROUND

A Dual-Subscriber Identity Module, Dual-Active (DSDA) mobile communication device can be in active call states with two parties via two subscriptions. Typically, with a DSDA mobile communication device, i.e., user equipment (UE), one subscription is enabled for data services, i.e., packet-switched (PS) calls, and voice services, i.e., circuit-switched (CS) calls (referred to as a CS+PS enabled subscription), for example, but not limited to, a Wideband Code Division Multiple Access (WCDMA) subscription, and the other subscription is enabled for only voice services (referred to as a CS Only subscription), for example, but not limited to, a Global System for Mobile communications (GSM) subscription. When two voice sessions are active simultaneously, i.e., one on each subscription, a user may participate in only one of the voice sessions while the voice call on the other subscription is kept on local hold; thus, one of the voice sessions will be kept alive while the other voice session on local hold is wasting the network resources.

In cases where a voice call is active on the CS Only subscription and a data call is active on the CS+PS enabled subscription and a call is then received on the CS+PS enabled subscription, the data call may be suspended to receive the incoming voice call, or the voice and data sessions on the CS+PS enabled subscription may transition to Dual Transfer Mode (DTM). However, if the data session is suspended the mobile communication device will not be able to perform any data activity while the call is active. On the other hand, if the mobile communication device transitions into DTM, the user will experience only one-fourth to one-half of the data rate as compared to a standalone data call.

### SUMMARY

Apparatuses and methods for automatically forwarding an incoming voice call on a circuit switched and packet switched enabled subscription to a circuit switched only subscription are provided.

According to various embodiments there is provided a method for automatic call forwarding. The method may include: designating a first subscription as a subscription to receive circuit switched (CS) calls and packet switched (PS) calls; designating a second subscription as a subscription to receive CS calls; and automatically forwarding a CS call received on the first subscription to the second subscription when a PS call is active on the first subscription.

According to various embodiments there is provided a mobile communication device. The mobile communication device may include: a first communications unit configured to receive circuit switched (CS) calls and packet switched (PS) calls on a first subscription; a second communications unit configured to receive circuit switched CS calls on a second subscription; and a control unit configured to cause automatic forwarding of a CS call received on the first subscription to the second subscription when a PS call is active on the first subscription.

According to various embodiments there is provided a method for automatic call forwarding. The method may include: designating a first subscription as a subscription to receive circuit switched (CS) calls and packet switched (PS) calls; designating a second subscription as a subscription to receive CS calls and PS calls; and automatically implementing call forwarding of CS calls for one of the first subscription and the second subscription that first initiates a PS call.

According to various embodiments there is provided a mobile communication device. The mobile communication device may include: means for designating a first subscription as a subscription to receive circuit switched (CS) calls and packet switched (PS) calls; means for designating a second subscription as a subscription to receive CS calls; and means for automatically forwarding a CS call received on the first subscription to the second subscription when a PS call is active on the first subscription.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a wireless communication device according to various embodiments;

FIG. 2 is a flowchart illustrating a method according to various embodiments; and

FIG. 3 is flowchart illustrating a method according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

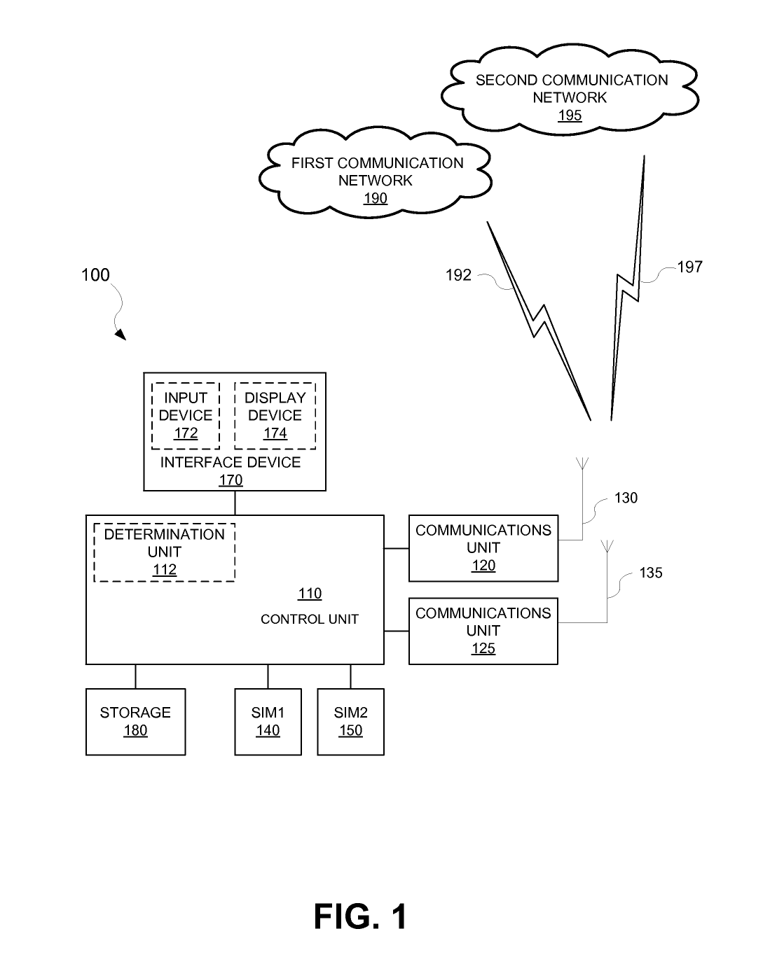

FIG. 1 is a block diagram illustrating a mobile communication device 100 according to various embodiments. As illustrated in FIG. 1, the mobile communication device 100 may include a control unit 110, a first communications unit 120, a second communications unit 125, a first antenna 130, a second antenna 135, a first SIM 140, a second SIM 150, a user interface device 170, and a storage 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communications units) and may interface with one or more antennas without departing from the scope of the present inventive concept.

The first communications unit 120 may include, for example, but not limited to, a first transceiver (not shown). The second communications unit 125 may include, for example, but not limited to, a second transceiver (not shown).

A SIM (e.g., 140, 150) in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the multi-SIM, Multi-Active (MSMA) communication device, and thus need not be a separate or removable circuit, chip, or card.

A SIM used in various embodiments may store user account information, an International Mobile Subscriber Identity (IMSI), a set of SIM application toolkit (SAT) commands and other network provisioning information, as well as provide storage space for phone book database of the user's contacts. As part of the network provisioning information, a SIM may store home identifiers (e.g., a System Identification Number (SID)/Network Identification Number (NID) pair, a Home Public Land Mobile Network (HPLMN) code, etc.) to indicate the SIM card network operator provider.

The first SIM 140 may associate the first communications unit 120 with a first subscription (Sub1) 192 on a first communication network 190 and the second SIM 150 may associate the second communications unit 125 with a second subscription (Sub2) 197 on a second communication network 195. In active mode, a communications unit receives and transmits signals. In idle mode, a communications unit receives but does not transmit signals.

For convenience, throughout this disclosure Sub1 is associated with the first communications unit 120 and Sub2 is associated with the second communications unit 125. One of ordinary skill in the art will appreciate that either subscription may be associated with either communications unit without departing from the scope of the present inventive concept.

The first communication network 190 and the second communication network 195 may be operated by the same or different service providers, and/or may support the same or different communication technologies, for example, but not limited to, WCDMA and GSM.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may be configured to control overall operation of the mobile communication device 100 including control of the first communications unit 120, the second communications unit 125, the user interface device 170, and the storage 180. The control unit 110 may be a programmable device, for example, but not limited to, a microprocessor or microcontroller.

The control unit 110 may include a determination unit 112 configured to determine if a PS call is active on Sub1 192 and/or if Sub2 197 is already engaged in a call when a forwarded Sub1 192 CS call is incoming on Sub2 197. Alternatively, the determination unit 112 may be implemented as electronic circuitry separate from the control unit 110.

The storage 180 may be configured to store application programs necessary for operation of the mobile communication device 100 that are executed by the control unit 110, as well as application data and user data.

Various embodiments provide automatic call forwarding for a mobile communication device 100 for automatically forwarding an incoming CS call on a designated CS+PS enabled subscription, for example Sub1 192, to a designated CS Only subscription, for example, Sub2 197, when Sub1 192 is engaged in an active data call. The designated CS+PS enabled subscription and CS Only subscription may be based on subscription plans purchased from providers. The subscriptions may be designated as CS+PS enabled and CS Only via input to the input device 172.

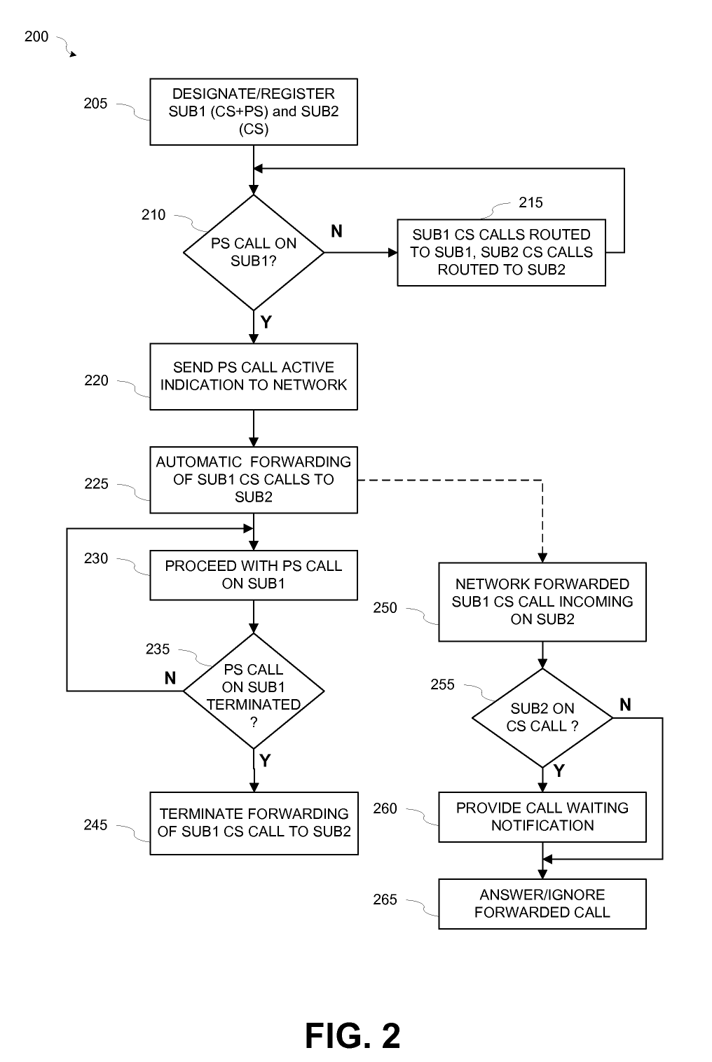

FIG. 2 is flowchart 200 illustrating a method according to various embodiments. With reference to FIGS. 1 and 2, Sub1 192 may be a designated CS+PS enabled subscription and may be registered for the call forward feature with the service provider for the first communication network 190 (205). Sub2 197 may be a designated CS Only subscription. Sub1 192 and Sub2 197 may be designated via input to the input device 172 and/or pre-registered with the service providers. The service provider for Sub1 192 may forward CS calls received on Sub1 192 to the Mobile Station International Subscriber Directory Number (MSISDN) for Sub2 197 when Sub1 192 is engaged in an active PS call.

The determination unit 112 may determine whether a PS call is active on Sub1 192 (210). If a PS call is not active on Sub1 192 (210-N), incoming CS calls on Sub1 192 may be routed to the Sub1 192 MSISDN and incoming CS calls on Sub2 197 may be routed to the Sub2 197 MSISDN (215), and the process 200 continues at operation 210.

If a PS call is active on Sub1 192 (210-Y), the control unit 110 may cause the mobile communication device 100 to send a communication to the first communication network 190 indicating that a PS call is active on Sub1 192 (220). In response to the communication from the mobile communication device 100, the first communication network 190 may initiate automatic call forwarding of incoming CS calls for Sub1 192 to the Sub2 197 MSISDN (225), and the PS call on Sub1 192 may remain active as the only call on Sub1 192 (230).

The determination unit 112 may determine whether a PS call on Sub1 192 has been terminated (235). If the PS call on Sub1 192 has not been terminated (235-N), the process 200 continues at operation 230. If the PS call on Sub1 192 has been terminated (235-Y), the first communication network 190 may terminate the automatic forwarding of incoming CS calls on Sub1 192 to the Sub2 197 MSISDN (245).

If a forwarded Sub1 192 CS call is incoming on Sub2 197 (250), the determination unit 112 may determine whether a CS call is already active on Sub2 197 (255). If a CS call is already active on Sub2 197 (255-Y), the control unit 110 may cause a call waiting notification to be displayed on the display device 174 (260) (or otherwise provide notification of the forwarded call), and the forwarded call to Sub2 197 may be answered or ignored (265).

If a CS call is not already active on Sub2 197 (255-N), the forwarded call may be answered or ignored (260) without a call waiting notification being displayed.

In various embodiments, both subscriptions may be CS+PS enabled subscriptions. For these embodiments, call forwarding may be automatically implemented as described for the first subscription to initiate a PS call. In various embodiments, one of the CS+PS enabled subscriptions may optionally be designated via input to the input device 172 and/or pre-registered with a service provider as the subscription to have a CS call automatically forwarded.

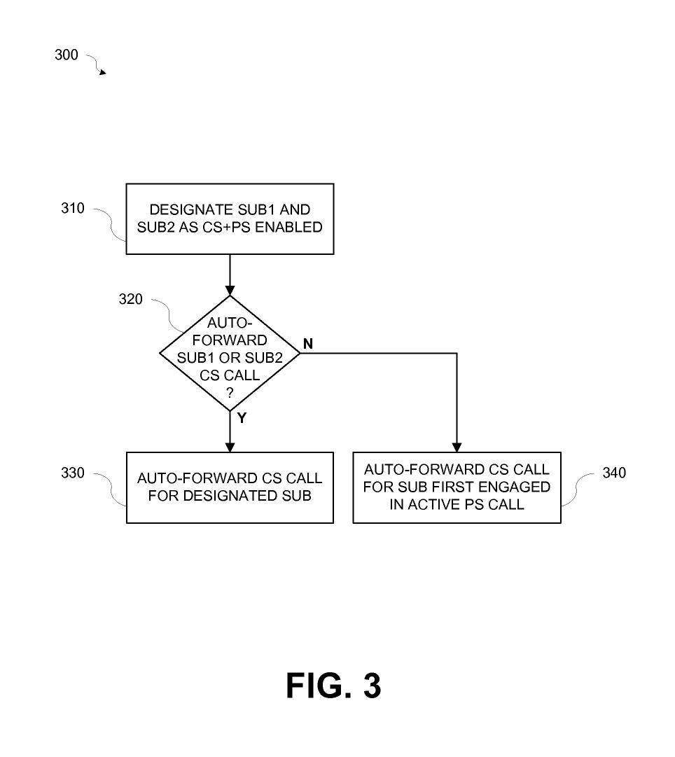

FIG. 3 is flowchart illustrating a method 300 according to various embodiments. With reference to FIGS. 1 and 3, Sub1 192 may be a designated CS+PS enabled subscription and Sub2 197 may be a designated CS+PS enabled subscription (310). If Sub1 192 or Sub2 197 is designated as a subscription to have a CS call automatically forwarded (320-Y), when the designated subscription (e.g., Sub1 192) is engaged in an active PS call, the control unit 110 may cause the service provider for the designated subscription to forward an incoming CS call on the designated subscription to the non-designated subscription (e.g., Sub2 197) (330).

If neither Sub1 192 nor Sub2 197 is designated as a subscription to have a CS call automatically forwarded (320-N), the control unit 110 may cause the service provider for the subscription first engaged in an active PS call (e.g., Sub1 192) to have an incoming CS call forwarded to the other subscription (e.g., Sub2 197) (340).

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method for automatic call forwarding, comprising:
designating a first subscription as a subscription to receive circuit switched (CS) calls and packet switched (PS) calls;
designating a second subscription as a subscription to receive CS calls; and
automatically forwarding a CS call received on the first subscription to the second subscription when a PS call is active on the first subscription.

2. The method of claim 1, further comprising:
determining whether a CS call is active on the second subscription, and
providing a call waiting notification in response to a determination that a CS call is active on the second subscription.

3. The method of claim 1, further comprising designating the first subscription as a subscription to receive CS calls and PS calls and designating the second subscription as a subscription to receive CS calls via input to an input device.

4. The method of claim 1, wherein the first subscription is a Wideband Code Division Multiple Access (WCDMA) subscription and the second subscription is a Global System for Mobile communications (GSM) subscription.

5. The method of claim 1, wherein the first subscription is different from the second subscription.

6. The method of claim 1, wherein the automatically forwarding a CS call comprises sending a notification to a network associated with the first subscription to forward incoming CS calls on the first subscription to the second subscription.

7. The method of claim 6, wherein the network associated with the first subscription forwards the incoming CS calls without user interaction.

8. The method of claim 1, further comprising:
designating the second subscription to receive PS calls in addition to receiving CS calls, and
automatically implementing call forwarding of CS calls for one of the first subscription and the second subscription that first initiates a PS call.

9. The method of claim 8, further comprising designating, via input to an input device, one of the first subscription and the second subscription as a subscription to have a CS call automatically forwarded.

10. The method of claim 8, wherein the first subscription is different from the second subscription.

11. A mobile communication device, comprising:
a first communications unit configured to receive circuit switched (CS) calls and packet switched (PS) calls on a first subscription;
a second communications unit configured to receive CS calls on a second subscription; and
a control unit configured to cause automatic forwarding of a CS call received on the first subscription to the second subscription when a PS call is active on the first subscription.

12. The mobile communication device of claim 11, further comprising a determination unit configured to determine whether a PS call is active on the first subscription.

13. The mobile communication device of claim 12, further comprising a display device,
wherein the determination unit is configured to determine whether a CS call is active on the second subscription, and
the control unit is configured to cause the display device to display a call waiting notification on the display device in response to a determination that a CS call is active on the second subscription.

14. The mobile communication device of claim 11, further comprising an input device,
wherein the first subscription is designated as a subscription to receive CS calls and PS calls and the second subscription is designated as a subscription to receive CS calls via input to the input device.

15. The mobile communication device of claim 11, wherein the first subscription is different from the second subscription.

16. The mobile communication device of claim 11, wherein the control unit is configured to send a notification to a network associated with the first subscription to forward incoming CS calls on the first subscription to the second subscription.

17. The mobile communication device of claim 16, wherein the network associated with the first subscription forwards the incoming CS calls without user interaction.

18. The mobile communication device of claim 11, wherein the second communications unit is further configured to receive PS calls on the second subscription in addition to receiving CS calls, and
the control unit is configured to implement automatic call forwarding of CS calls for one of the first subscription and the second subscription that first initiates a PS call.

19. The mobile communication device of claim 18, further comprising an input device, wherein one of the first subscription and the second subscription is designated via input to the input device as a subscription to have a CS call automatically forwarded.

20. The mobile communication device of claim 18, wherein the first subscription is different from the second subscription.

21. A method for automatic call forwarding, comprising:
designating a first subscription as a subscription to receive circuit switched (CS) calls and packet switched (PS) calls;
designating a second subscription as a subscription to receive CS calls and PS calls; and
automatically implementing call forwarding of CS calls for one of the first subscription and the second subscription that first initiates a PS call.

22. The method of claim 21, further comprising designating, via input to an input device, one of the first subscription and the second subscription as a subscription to have a CS call automatically forwarded.

23. The method of claim 21, wherein the first subscription is different from the second subscription.

24. A mobile communication device, comprising:
means for designating a first subscription as a subscription to receive circuit switched (CS) calls and packet switched (PS) calls;
means for designating a second subscription as a subscription to receive CS calls; and
means for automatically forwarding a CS call received on the first subscription to the second subscription when a PS call is active on the first subscription.
